(19) United States
(12) Patent Application Publication
(10) Pub. No.: US 2016/0378410 A1
(43) Pub. Date: Dec. 29, 2016

(54) INFORMATION TERMINAL, METHOD OF CONTROLLING SAME, AND STORAGE MEDIUM

(71) Applicant: CANON KABUSHIKI KAISHA, Tokyo (JP)

(72) Inventor: Go Inoue, Abiko-shi (JP)

(21) Appl. No.: 15/173,432

(22) Filed: Jun. 3, 2016

(30) Foreign Application Priority Data
Jun. 23, 2015 (JP) 2015-125945

(51) Int. Cl. G06F 3/12; H04N 1/00

(52) U.S. Cl. CPC G06F 3/1236; G06F 3/1293; H04N 1/00411; H04N 1/00482; G06F 3/1292; G06F 3/1204; H04N 2201/0039; H04N 2201/0055

(57) ABSTRACT

A mobile terminal, which is an information terminal, finds a printing apparatus positioned in a vicinity of the mobile terminal by wireless communication such as Bluetooth communication or WiFi communication. Furthermore, a printing apparatus from the found printing apparatuses that satisfies a predetermined condition, for example that is closest to the mobile terminal, is decided upon, and when displaying a printing apparatus setting screen in accordance with a user operation, the setting screen is displayed in an operation unit in a state in which setting details of the decided printing apparatus are displayed.

### BACKGROUND OF THE INVENTION

Field of the Invention

The present invention relates to an information terminal, a method of controlling the same, and a storage medium.

Description of the Related Art

In the past few years, for mobile terminals, such as information terminals, those with a wireless LAN function or a Bluetooth (registered trademark) function have been increasing. If executing print processing from a mobile terminal to a printing apparatus, such as a printer or a multi-function peripheral, it is typical to use a wireless LAN. For example, there is a method of transmitting print data via an access point, and a method of transmitting print data by wireless direct communication directly to the printing apparatus, without going through an access point. In addition, there is a method that transmits print data to a printing apparatus by using Bluetooth, but a communication speed is slower in comparison to a wireless LAN.

Meanwhile, to print from the mobile terminal, it is necessary to select a printing apparatus. For example, Japanese Patent Laid-Open No. 2005-130293 proposes, as a method of searching for a printing apparatus from a mobile terminal, a method in which a user executes a process for searching for a printing apparatus from a search screen of a mobile terminal. The search process is performed by transmitting a wireless LAN multi-cast packet or broadcast packet for example, where printing apparatuses from which there is a response are added to a printer list. A user selects any one printing apparatus from the printer list, and executes print processing.

However, the above conventional technique has a problem that is described below. For example, if a user wishes to execute printing on a printing apparatus, even if the user is beside the printing apparatus, there is a need to open a search screen to execute a search, and select the printing apparatus that is right in front of the user from the printer list. In addition, because a particular interval is required until a search result is obtained, display of the printer list takes time, and this becomes a cause of stress for the user. Furthermore, there is a need to press a print execution button at a time of print execution, and this requires an operation by the user.

### SUMMARY OF THE INVENTION

The present invention enables realization of an arrangement in which, when inputting a job to a printing apparatus by wireless communication, an appropriate printing apparatus is automatically selected by default in a setting screen before a user performs setting in relation to print processing.

One aspect of the present invention provides an information terminal for transmitting print data to a printing apparatus, the information terminal comprising: a reception unit configured to receive a packet transmitted from a printing apparatus; a specification unit configured to specify a printing apparatus closest to the information terminal, based on the packet received by the reception unit; and a display unit configured to display a print setting screen for a user to select a printing apparatus to be a print data transmission destination, wherein the specification unit specifies the printing apparatus closest to the information terminal before the display unit displays the print setting screen, and in response to accepting an instruction to display the print setting screen from a user, the display unit displays the print setting screen in a state in which the printing apparatus specified by the specification unit is selected as the print data transmission destination.

Another aspect of the present invention provides a method of controlling an information terminal for transmitting print data to a printing apparatus, the method comprising: receiving a packet transmitted from a printing apparatus; specifying a printing apparatus closest to the information terminal, based on the received packet; and displaying a print setting screen for a user to select a printing apparatus to be a print data transmission destination, wherein the printing apparatus closest to the information terminal before the display unit displays the print setting screen is specified, and in response to accepting an instruction to display the print setting screen from a user, the print setting screen is displayed in a state in which the specified printing apparatus is selected as the print data transmission destination.

Still another aspect of the present invention provides a non-transitory computer-readable storage medium storing a computer program for causing a computer to execute a method of controlling an information terminal for transmitting print data to a printing apparatus, the method comprising: receiving a packet transmitted from a printing apparatus; specifying a printing apparatus closest to the information terminal, based on the received packet; and displaying a print setting screen for a user to select a printing apparatus to be a print data transmission destination, wherein the printing apparatus closest to the information terminal before the display unit displays the print setting screen is specified, and in response to accepting an instruction to display the print setting screen from a user, the print setting screen is displayed in a state in which the specified printing apparatus is selected as the print data transmission destination.

Further features of the present invention will be apparent from the following description of exemplary embodiments with reference to the attached drawings.

### BRIEF DESCRIPTION OF THE DRAWINGS

FIG. 1 is a view for illustrating a configuration of a printing system.

FIG. 2 is a view for illustrating a configuration of a mobile terminal.

FIG. 3A to FIG. 3C are views for illustrating an operation screens displayed by an operation unit.

FIG. 4A to FIG. 4C are views for illustrating an operation screens displayed by an operation unit.

FIG. 5 is a flowchart for illustrating processing in which the mobile terminal executes printing apparatus pairing.

FIG. 6 is a flowchart for illustrating processing in which the mobile terminal executes printing.

FIG. 7 is a flowchart for illustrating processing in which the mobile terminal executes printing apparatus searching.

FIG. 8 is a flowchart for illustrating processing in which the mobile terminal executes pairing in accordance with BLE.

FIG. 9 is an example of a BLE advertising packet.

FIG. 10 is a flowchart for illustrating processing in which the mobile terminal prompts enabling of wireless communication.

FIG. 11 is a flowchart for illustrating processing in which the mobile terminal automatically enables wireless communication.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

<Configuration of Printing System>

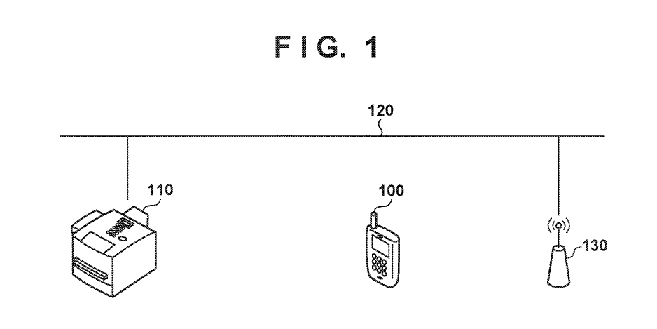

Below, explanation will be given for a first embodiment of the present invention. Firstly, explanation is given regarding a configuration of a printing system according to the present embodiment, with reference to FIG. 1. The printing system includes a mobile terminal 100, which is an information terminal, a printing apparatus 110, and an access point 130.

The access point 130 and the printing apparatus 110 are connected to a network 120, and can communicate with the mobile terminal 100 via the network 120. In addition, if the mobile terminal 100 and the printing apparatus 110 are equipped with a wireless direct communication function, they can perform direct communication without going through the network 120. The mobile terminal 100 transmits print data to the printing apparatus 110, and the printing apparatus 110, having received the print data, interprets the received the print data and then executes print processing. Note that, although to simplify the explanation, explanation is given of an example in which the printing system in the present embodiment includes one of each of the printing apparatus 110, the mobile terminal 100, and the access point, it may actually include a plurality of other printing apparatuses, mobile terminals, and access points.

<Configuration of Mobile Terminal>

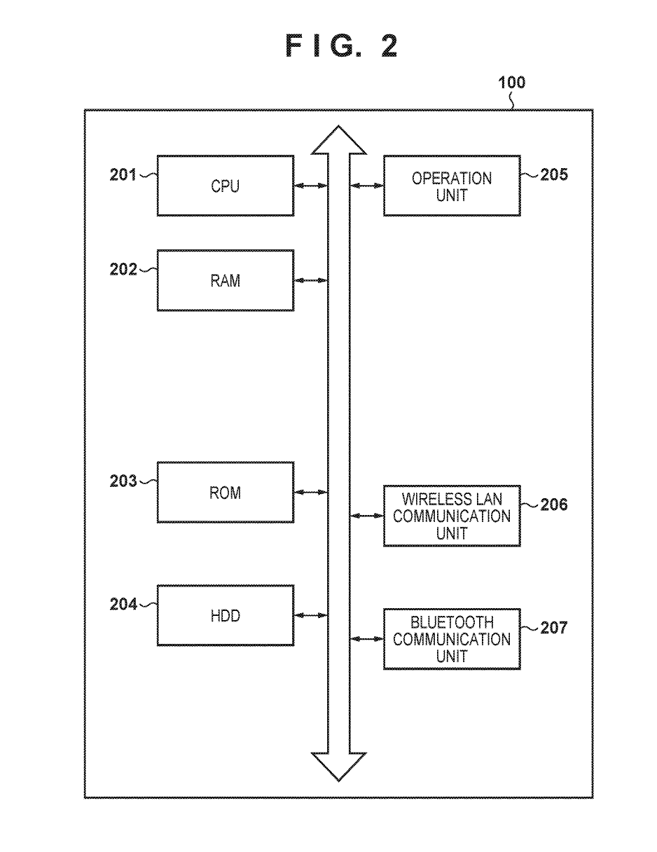

Next, explanation is given of a configuration of the mobile terminal 100, with reference to FIG. 2. The mobile terminal 100 is provided with a CPU 201, a RAM 202, a ROM 203, an HDD 204, an operation unit 205, a wireless LAN communication unit 206, and a Bluetooth communication unit 207.

The CPU 201 reads control programs stored in the ROM 203, to execute various processing for controlling operation of the mobile terminal 100. The ROM 203 stores the control program. The RAM 202 is used as a temporary storage area, such as a work area or a main memory of the CPU 201. The HDD 204 stores various data, such as print data and scanned images. Note that in the case of the mobile terminal 100, explanation is given of one CPU 201 executing each process illustrated in flowcharts explained later, but another configuration may be used. For example, each process illustrated in the flowcharts explained later may be executed by a plurality of CPUs cooperating.

In addition to functioning as a reception unit, the operation unit 205 is provided with a soft keyboard or a liquid crystal display unit that has a touch panel function, and displays various screens described later. A user can input information or an instruction to the mobile terminal 100 via the operation unit 205. The wireless LAN communication unit 206 executes wireless communication, by a wireless LAN, with an external apparatus such as the access point 130. The Bluetooth communication unit 207 executes wireless communication by Bluetooth with an external apparatus such as the printing apparatus 110.

<Operation Screens>

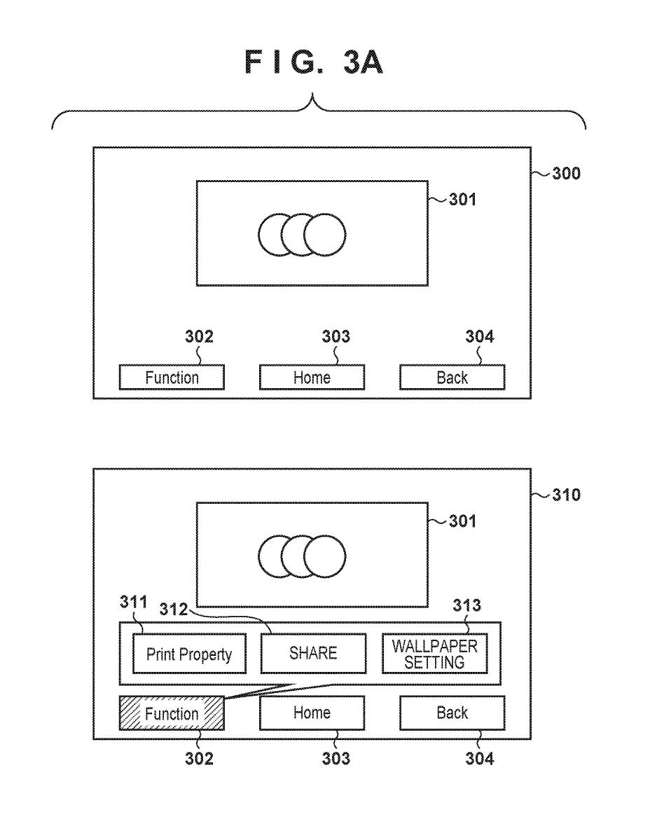

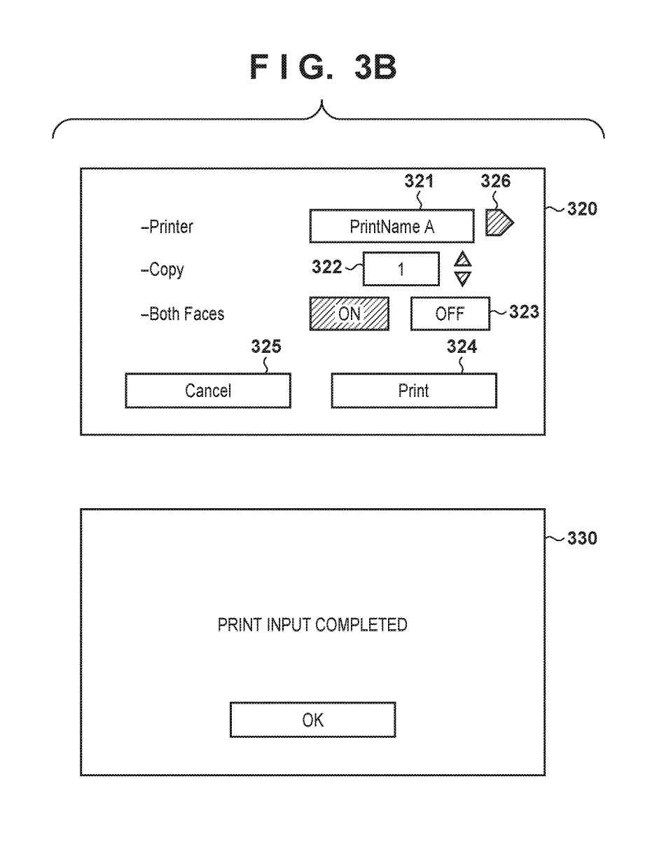

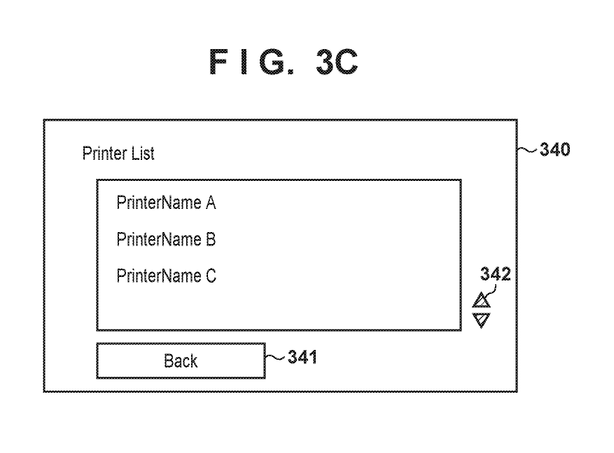

Next, with reference to FIG. 3A to FIG. 3C, explanation is given relating to operation screens that the operation unit 205 displays and operation procedures when a user executes printing, searching and selection of a printer.

A menu screen 300 illustrated in FIG. 3A is a screen that the operation unit 205 of the mobile terminal 100 displays. The menu screen 300 displays image data 301, and is configured from a function button 302 that can perform an operation of a particular function with respect to the image, a home button 303 for a home screen of the operation unit 205, and a back button 304 for a previous screen. If a user selects the function button 302, a transition is made to a screen 310, which is illustrated in FIG. 3A.

A wallpaper setting button 313, a share button 312, and a printer property button 311, for example, are displayed in the screen 310 as buttons for selecting a function. If a user selects the printer property button 311, a transition is made to a screen 320 illustrated in FIG. 3B, which relates to print processing. If the share button 312 is selected, a function for sharing the image data with another mobile terminal 100 is executed, for example. If the wallpaper setting button 313 is selected, a function for setting the image data as a wallpaper of the operation unit 205 is executed.

When the mobile terminal 100 has displayed the screen 320, the screen 320 is displayed in a state in which a printing apparatus at a distance closest to the mobile terminal 100 is selected in a printer name item 321. The screen 320 is in a state in which predetermined printer setting details are reflected. A processing flow in which a printing apparatus has already been selected in this way is explained later. In addition, settings in accordance with attribute information of the printing apparatus are displayed in the screen 320. For example, if the printing apparatus is provided with a double-sided printing function, a setting item 323 for a double-sided printing is displayed. In addition, a user can change a number of print copies by changing a setting item 322.

Note that, in the present embodiment explanation is given having a condition that the printing apparatus be at a distance closest from the mobile terminal 100 is given as a predetermined condition for selecting a printing apparatus, but the present invention is not limited to this, and configuration may be taken to replace this with another condition or add another condition. As another condition, for example there is a condition that a printing apparatus be currently usable, a condition that a printing apparatus can predict the settings of a print job that a user is to input and execute the setting details, or a condition that a printing apparatus have a high use frequency by users.

In a state in which the screen 320 is displayed in the operation unit 205, there are two methods by which a user executes printing. One is a method in which a user selects a print execution button 324. If a user operates the print execution button 324, the mobile terminal 100 uses wireless communication to transmit print data to the printing apparatus 110. When printing has completed, the mobile terminal 100 displays a screen 330 that indicates print completion, illustrated in FIG. 3B.

The other method is by a user causing the mobile terminal 100 to approach within a fixed distance from the printing apparatus 110. For example, upon approaching to a distance of about 10 cm so that the mobile terminal 100 is caused to touch the printing apparatus 110, the mobile terminal 100 detects that it has approached within a fixed distance from the printing apparatus 110, and uses wireless communication to transmit print data to the printing apparatus 110. When printing has completed, the mobile terminal 100 displays a screen 330 that indicates print completion.

If a user wishes to select another printing apparatus in the screen 320, they select a search button 326. If the search button 326 is selected, the mobile terminal 100 displays, as in a screen 340 of FIG. 3C, a list obtained in accordance with a search flow explained later. If a user selects one printing apparatus from this list and operates a back button 341, the screen 320 is transitioned to. Note that, scroll buttons 342 is provided in the screen 340, and by operating these buttons, it is possible to cause the list to move up and down, and it is also possible to display a printing apparatus not displayed on the screen.

In addition, if a cancel button 325 in the screen 320 is selected, detail set in the screen 320 is discarded, and a screen 300 is returned to. In contrast, if the print execution button 324 is selected, a print job for details set in the screen 320 is transmitted to a printing apparatus that is set. In such a case, the screen 330 illustrated in FIG. 3B is transitioned to, and it is displayed that input of the print job to a predetermined printing apparatus has completed. If an OK button is operated in the screen 330, the screen 300 is transitioned to.

<Processing Flow>

In the description above, explanation was given, with reference to FIG. 3A to FIG. 3C, of operation procedures for when executing a print job from the mobile terminal 100. In contrast, for processing that the CPU 201 executes in each operation procedure, explanation is given below using flowcharts. Each step illustrated in each flowchart is processed by the CPU 201 loading a control program stored in a memory, such as the ROM 203, into the RAM 202, and then executing the control program.

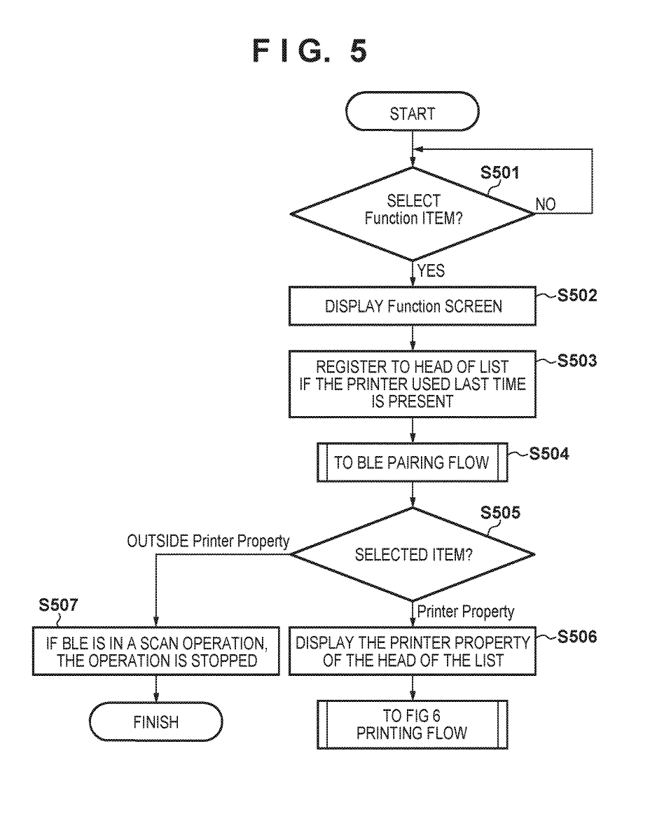

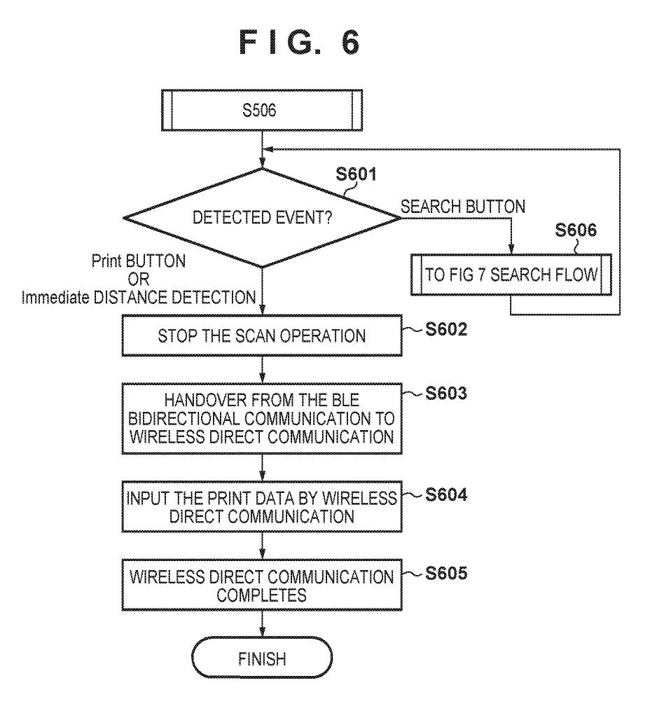

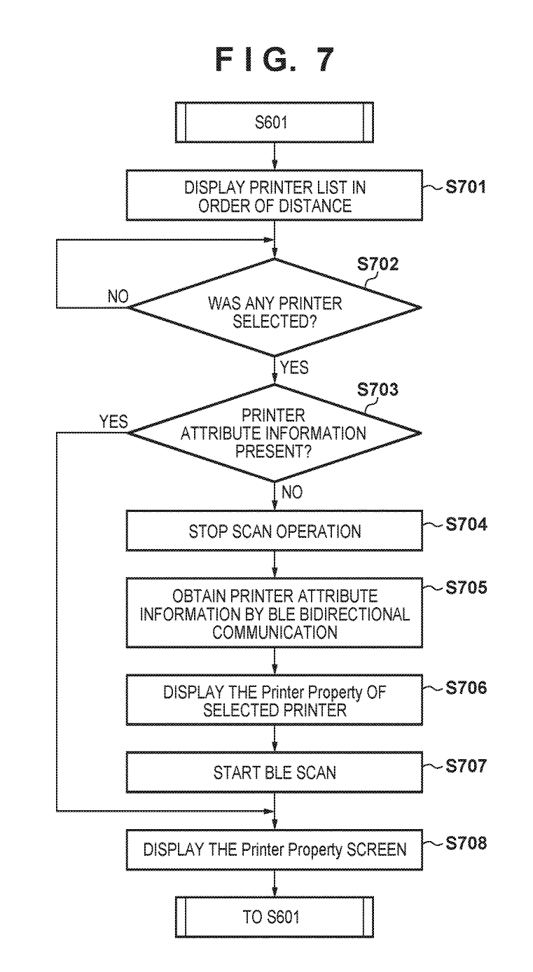

The processing flow in present embodiment is broadly divided to be configured from a printing apparatus pairing flow of FIG. 5, a printing flow of FIG. 6, and a search flow of FIG. 7.

Firstly explanation is given regarding the pairing flow, with reference to FIG. 5. Here, firstly processing is started in a state in which the screen 300 is displayed in the operation unit 205 of the mobile terminal 100. In step S501, the CPU 201 determines whether a user operation for displaying the screen 310 for selecting a function has been performed in the screen 300. Specifically, it is determined whether an operation of the function button 302 of the screen 300 has been accepted. If it is determined that the operation has been accepted, the processing proceeds to step S502, and otherwise the determination of step S501 is performed periodically.

In step S502, the CPU 201 displays on the operation unit 205 the screen 310 for selecting a function, and the processing proceeds to step S503. In step S503, if the printing apparatus that the user selected the previous time is present, the CPU 201 registers it at the head of a printer list that is held in the RAM 202. Here, the printer registered at the head of the printer list is displayed as the printer selected by default in the screen 320, for example. Next, in step S504, the CPU 201 uses Bluetooth Low Energy (hereinafter, abbreviated as BLE) advertising to execute printing apparatus pairing processing.

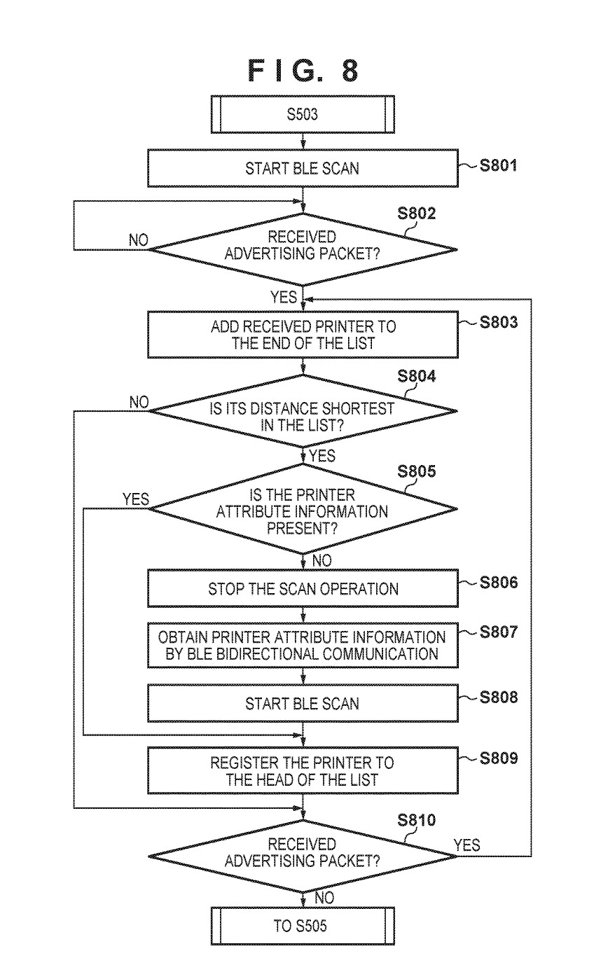

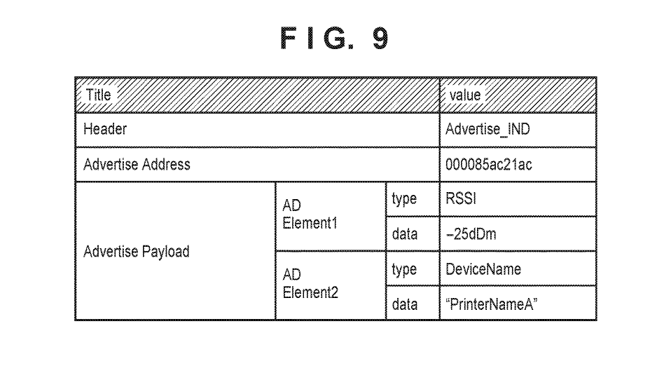

Here, the flowchart of FIG. 8 is used to explain a pairing flow that uses BLE and corresponds to the processing of step S504. Firstly, in step S801, the CPU 201 performs control for initiating BLE scan processing via the Bluetooth communication unit 207. Next, in step S802, the Bluetooth communication unit 207 determines whether it has received a BLE advertising packet as illustrated in FIG. 9 from a printing apparatus in the vicinity. If received, the processing proceeds to step S803, and if not received the determination of step S802 is periodically repeated.

In step S803, the CPU 201 adds a printing apparatus ID included in the received packet to the end of the printer list. In the present embodiment, a device name is used as an ID for specifying a printing apparatus, but a type such as an IP address or a MAC address is irrelevant if it can uniquely specify a printing apparatus. Accordingly, in the example of FIG. 9, “PrinterNameA” is the printing apparatus ID. In addition, if it is an ID that has already been added to the printer list, it is desirable to not add it to the printer list.

Next, in step S804, the CPU 201 uses a radio field intensity (RSSI) of the received packet to determine whether the printing apparatus corresponding to the received packet is in the plurality of printing apparatuses included in the list, and is the one for which distance to the mobile terminal 100 is shortest. The radio field intensity of the printing apparatus illustrated in the example of FIG. 9 is −25 dBm. If it is determined that another printing apparatus already registered in the printer list is the shortest distance from the mobile terminal 100, the processing proceeds to step S810, and if it is determined that the printing apparatus corresponding to the received packet is closest to the mobile terminal 100, the processing proceeds to step S805. In step S810, the CPU 201 waits for reception of a subsequent advertising packet.

In contrast, in step S805, if the CPU 201 determines that the printing apparatus corresponding to the received packet is positioned at a distance closest to the mobile terminal 100, the CPU 201 determines whether printer attribute information is included in the received advertising packet. Whether an advertising packet includes attribute information differs depending on the printing apparatus. However, as illustrated in FIG. 9, for a BLE advertising packet, because a data size of the packet itself is typically small at several tens of bytes, it cannot sufficiently include detailed printer attribute information. Therefore, if it is not possible to obtain, from the advertising packet, printer attribute information sufficient to display on the screen 320 of the mobile terminal 100, the processing proceeds to step S806. However, if obtaining is possible, the processing proceeds to step S809.

In step S806, the CPU 201 temporarily stops BLE scan operation, and in step S807 establishes a connection for BLE bidirectional communication (GATT communication) with a desired printing apparatus and then obtains printer attribute information. If obtaining of the printer attribute information completes, the bidirectional communication is cut, and, in step S808, the CPU 201 resumes the BLE scan operation. Temporarily stopping the BLE scan operation is necessary if it is not possible to simultaneously perform the BLE scan operation and a bidirectional communication operation in parallel. However, there is no necessity to stop the BLE scan operation in the case of a terminal provided with a function that can simultaneously perform a BLE scan operation and a bidirectional communication operation in parallel. If this processing flow terminates, the CPU 201 returns the processing to step S505.

The explanation of FIG. 5 is returned to. In step S505, the CPU 201 determines an item selected in the screen 310. Here, if the printer property button 311 has been selected, the processing proceeds to step S506, and if a button other than the printer property button 311 has been selected, the processing proceeds to step S507.

In step S506, the CPU 201 displays the screen 320 for printer properties, and proceeds to a printing flow illustrated in FIG. 6. In the present embodiment, because printing apparatus pairing and obtaining attribute information is caused to complete before the printer property screen of the screen 320 is displayed, when displaying a printer property screen, it is possible to display a screen transition without delay. It is possible to display in a state in which a printing apparatus that is present at a distance closest from the mobile terminal 100 is selected in a default state.

Meanwhile, in step S507, the CPU 201 stops the scan operation if in a BLE scan state, and terminates processing.

Next, with reference to FIG. 6, explanation is given with respect to a printing flow executed continuing from the processing of step S506. In step S601, in a state in which the screen 320 is displayed on the operation unit 205, the CPU 201 determines whether it has detected an event. An event is, for example, a press of the print execution button 324 to indicate print initiation, or a case such as where is determined that a printing apparatus selected by the mobile terminal 100 has been approached within a fixed distance. If an event is detected, the processing proceeds to step S602. If an event is not detected, the processing proceeds to step S606. Detailed processing of step S606 is described later using FIG. 7.

Determination of the fixed distance is, for example, by periodically scanning BLE advertising packets transmitted from the printing apparatus, and determining from the radio field intensity whether within the fixed distance has been reached. The fixed distance can be changed by a setting on the mobile terminal 100 side, and, for example, if wishing to detect a short distance close to a touch such as 10 cm, configuration may be taken to set a threshold value to −30 dBm or the like. In the present embodiment, 10 cm is expressed as an Immediate distance.

In step S602, the CPU 201 stops the scan operation. Next, in step S603, the mobile terminal 100 establishes BLE bidirectional communication with the printing apparatus 110, and exchanges information for performing wireless LAN communication. If the information exchange for wireless LAN communication completes, the CPU 201 cuts the BLE bidirectional communication, and establishes wireless LAN communication with the printing apparatus 110 based on the obtained information. In other words, a handover from BLE bidirectional communication to wireless direct communication is performed here. Next, in step S604, the CPU 201 transmits the print data to the printing apparatus by the established wireless LAN communication. Finally, in step S605, the CPU 201 terminates the wireless LAN connection if transmission of the print data completes.

Next, with reference to FIG. 7, explanation is given with respect to a search flow corresponding to the processing of the above described step S606. Firstly, in step S701, if a Bluetooth setting of the mobile terminal 100 is enabled, the CPU 201 displays the printer list that was created in step S803 in the operation unit 205. At this point, by displaying the list after it has been sorted into an order from the closest distance from the mobile terminal 100, the list becomes one material for the user to make a decision when selecting a printing apparatus.

Next, in step S702, the CPU 201 determines whether one printing apparatus has been selected by a user. If selected, the processing proceeds to step S703, and if not selected the determination of step S702 is periodically repeated. In step S703, the CPU 201 determines whether attribute information of the printing apparatus selected by the user is present. If present the processing proceeds to step S708, and if not the processing proceeds to step S704. As mentioned previously, because a size capacity for a typical advertising packet is not so large that it can include attribute information, in step S704, the CPU 201 stops the BLE scan operation, and, in step S705, the CPU 201 establishes BLE bidirectional communication to obtain printer attribute information from the corresponding printing apparatus. Furthermore, in step S706, the CPU 201 analyzes the obtained printer attribute information, and sets it as the properties of the selected printing apparatus, as displayed in the screen 320. Thereafter, in step S707, the CPU 201 resumes the BLE scan, and the processing proceeds to step S708. In step S708, the CPU 201 displays the screen 320 on the operation unit 205, and returns the processing to step S601.

As explained above, by virtue of the present embodiment, the mobile terminal 100, which is an information terminal, finds printing apparatuses positioned in the vicinity of the mobile terminal 100 by wireless communication, such as Bluetooth communication or WiFi communication. Furthermore, a printing apparatus from the found printing apparatuses that satisfies a predetermined condition, for example that is closest to the mobile terminal, is decided upon, and when displaying a printing apparatus setting screen in accordance with a user operation, the setting screen is displayed in the operation unit 205 in a state in which setting details of the decided printing apparatus are displayed. In other words, by virtue of the present embodiment, before a user executes a print operation, an operation screen is displayed in which a printing apparatus at a distance closest to the user is automatically selected by default, by using Bluetooth communication for example. With this, it is convenient for a user because a printer that is close is immediately displayed after performing an operation for printing. In other words, it is possible to provide a user-friendly system of operation. In addition, by displaying a printer property screen or a printer list screen without a time delay configuration is such that the user is enabled to operate a screen without being given stress. It is also possible to simplify an operation procedure for a user by automating print execution processing in accordance with BLE communication distance detection.

In addition, the present invention is not limited to the above described embodiment, and various transformations are possible. In the above first embodiment, as the printing apparatus displayed on the screen 320 by default, one for which distance from the mobile terminal is closest in accordance with radio field intensity is selected. However, the present invention is not limited to this, and configuration may be taken to select a printing apparatus to display by default in accordance with other information.

### Second Embodiment

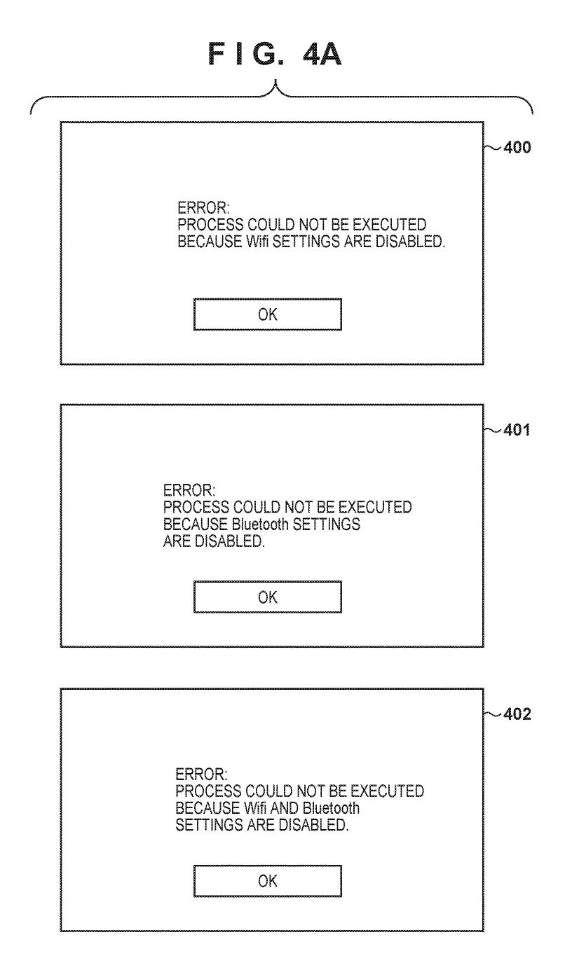

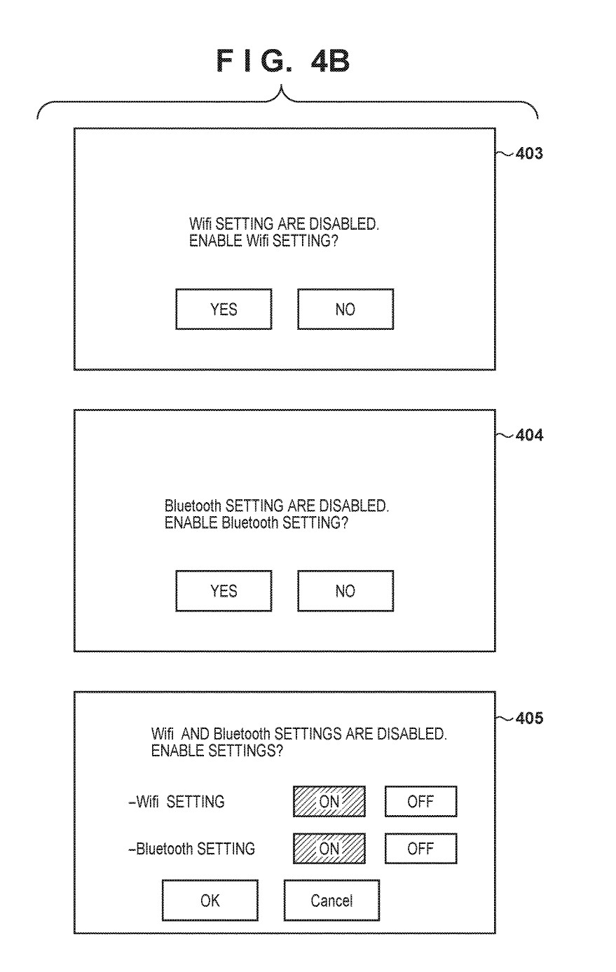

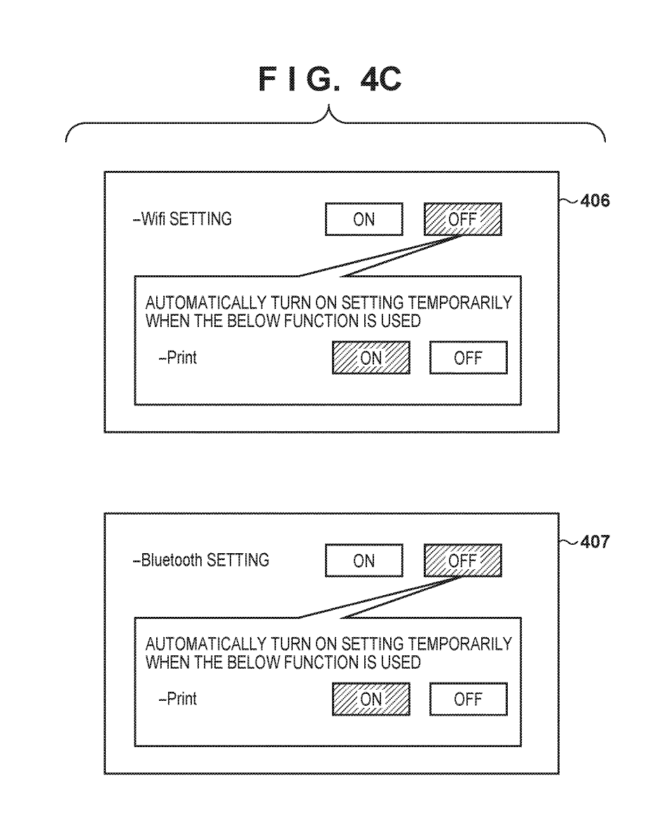

Below, explanation will be given for a second embodiment of the present invention. Because a configuration of the mobile terminal 100 and the printing system of the present embodiment is similar to the configuration explained using FIG. 1 and FIG. 2, explanation thereof is omitted. The case of the present embodiment differs to that of the above first embodiment in that, if a communication setting of the mobile terminal 100 is disabled, a user is prompted to enable the setting. In the above first embodiment, if processing cannot be performed in the flows because a wireless LAN setting or a Bluetooth setting is disabled, one of a screen 400 to a screen 402 illustrated in FIG. 4A, in other words an error screen, is displayed in the operation unit 205. If such an error screen is displayed in the operation unit 205, it means that processing being executed has failed and terminated in error.

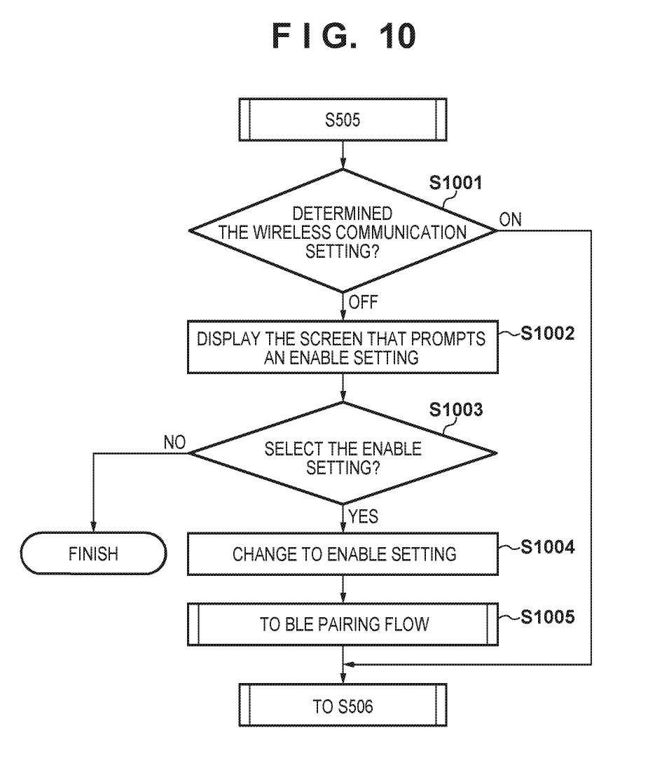

In contrast, in the present embodiment, if a wireless LAN setting or a Bluetooth setting is disabled, display control of the display unit in the operation unit 205 is performed so that a user is prompted to enable it. A detailed processing flow is explained with reference to FIG. 10. This processing flow is performed after the processing of the above step S505.

In step S1001, before displaying the screen 320, the CPU 201 determines whether a wireless communication setting, such as Bluetooth or a wireless LAN, of the mobile terminal 100 is enabled. If it is determined that wireless communication setting is disabled, the processing proceeds to step S1002, and if it is enabled the processing returns to step S506.

In step S1002, the CPU 201, without displaying the error screen illustrated in FIG. 4A, displays in the operation unit 205 one of a screen 403 to a screen 405 illustrated in FIG. 4B. The screen 403 is a setting screen for WiFi communication, a screen 404 is a setting screen for Bluetooth communication, and the screen 405 is a setting screen for WiFi and Bluetooth. By using the screen 403 to the screen 405, a user can set a setting that was disabled (a wireless LAN setting or a Bluetooth setting) to enabled.

In step S1003, the CPU 201 determines whether a user has selected to enable a setting. If a setting is enabled, the processing proceeds to step S1004. In step S1004, the CPU 201 enables wireless communication, performs a pairing flow by BLE in step S1005, and returns the processing to step S506. Thereafter, a print processing flow by the wireless LAN is performed as described above. However, if a user leaves the settings as disabled in step S1003, an error screen is displayed in the operation unit 205 similarly to in the above first embodiment, and processing stops.

As explained above, by virtue of the present embodiment, even if a communication setting has been disabled in the mobile terminal 100, by displaying a screen that prompts a user to enable the setting, the user can easily grasp the reason for failure, and also easily perform a setting change to cause a print operation to succeed.

### Third Embodiment

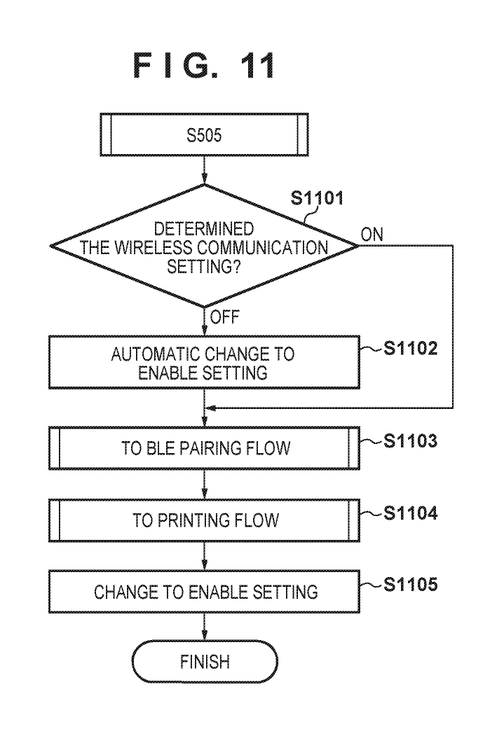

Below, explanation will be given for a third embodiment of the present invention. Because a configuration of the mobile terminal 100 and the printing system of the present embodiment is similar to the configuration explained using FIG. 1 and FIG. 2, explanation thereof is omitted. The case of the present embodiment differs to that of the above second embodiment in that, if a communication setting of the mobile terminal 100 is disabled, the setting is enabled automatically, and then the processing continues. A detailed processing flow is explained with reference to FIG. 11. This processing flow is performed after the processing of the above step S505.

In step S1101, before displaying the screen 320, the CPU 201 determines whether a wireless communication setting, such as Bluetooth or a wireless LAN, of the mobile terminal 100 is enabled. If it is determined that wireless communication setting is disabled, the processing proceeds to step S1102, and if it is enabled the processing proceeds to step S1103.

In step S1102, the CPU 201 automatically changes disabled wireless communication to enabled. Here, as a method for automatically enabling disabled wireless communication, for example, configuration may be taken to control so that it is realized by a printing application such as a printer driver requesting an OS (operating system) for a setting change. Next, in step S1103, the CPU 201 performs the BLE pairing flow, and performs the printing flow by wireless LAN in step S1104. Finally, in step S1105, the CPU 201 returns the enabled wireless communication to a disabled state. Note that, the wireless communication is returned to a disabled state to return to a setting for before the processing flow was executed, but configuration may be taken to control so that the disabled state is not returned to. Note that it goes without saying that returning is not necessary if it was originally enabled.

There are cases in which wireless LAN and Bluetooth settings of the mobile terminal 100 are generally disabled from a power consumption or security perspective depending on the user. So it is used by enabling the setting only at a time of printing or a time of Internet access. Even with such a user, by virtue of the present embodiment, it is possible to execute print processing without the user performing an operation to enable the setting.

In addition, the present invention is not limited to the above described embodiment, and various transformations are possible. Configuration may be taken to switch in accordance with user input by providing in the mobile terminal 100 a switch for whether to automatically enable settings at a time of printing, as in a screen 406 and a screen 407 of FIG. 4C, for example. The screen 406 is a setting screen for WiFi, and the screen 407 is a setting screen for Bluetooth. If this switch is enabled, in a case where the setting is disabled in the previously explained flows, switching between continuation of processing by internally enabling a setting, and error termination is performed in accordance with a setting value of the switch.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-125945 filed on Jun. 23, 2015, which is hereby incorporated by reference herein in its entirety.

What is claimed is:

1. An information terminal for transmitting print data to a printing apparatus, the information terminal comprising:
a reception unit configured to receive a packet transmitted from a printing apparatus;
a specification unit configured to specify a printing apparatus closest to the information terminal, based on the packet received by the reception unit; and
a display unit configured to display a print setting screen for a user to select a printing apparatus to be a print data transmission destination,
wherein the specification unit specifies the printing apparatus closest to the information terminal before the display unit displays the print setting screen, and
in response to accepting an instruction to display the print setting screen from a user, the display unit displays the print setting screen in a state in which the printing apparatus specified by the specification unit is selected as the print data transmission destination.

2. The information terminal according to claim 1, wherein
the specification unit specifies the printing apparatus closest to the information terminal based on a radio field intensity of the packet received by the reception unit.

3. The information terminal according to claim 1, wherein
the specification unit specifies the printing apparatus closest to the information terminal based on a BLE advertising packet received by the reception unit.

4. The information terminal according to claim 1, wherein
the print setting screen is a screen for a user to perform a designation of a print setting, in addition to selection of the printing apparatus to be the print data transmission destination.

5. The information terminal according to claim 4, wherein
the print setting is a setting for a double-sided printing.

6. The information terminal according to claim 4, wherein
the print setting is a setting for a number of print copies.

7. The information terminal according to claim 1, wherein
the print setting screen further displays a selection object for a user to select, as the print data transmission destination, another printing apparatus different to the printing apparatus specified by the specification unit.

8. A method of controlling an information terminal for transmitting print data to a printing apparatus, the method comprising:
receiving a packet transmitted from a printing apparatus;
specifying a printing apparatus closest to the information terminal, based on the received packet; and
displaying a print setting screen for a user to select a printing apparatus to be a print data transmission destination, wherein
the printing apparatus closest to the information terminal before the display unit displays the print setting screen is specified, and
in response to accepting an instruction to display the print setting screen from a user, the print setting screen is displayed in a state in which the specified printing apparatus is selected as the print data transmission destination.

9. A non-transitory computer-readable storage medium storing a computer program for causing a computer to execute a method of controlling an information terminal for transmitting print data to a printing apparatus, the method comprising:
receiving a packet transmitted from a printing apparatus;
specifying a printing apparatus closest to the information terminal, based on the received packet; and
displaying a print setting screen for a user to select a printing apparatus to be a print data transmission destination, wherein
the printing apparatus closest to the information terminal before the display unit displays the print setting screen is specified, and
in response to accepting an instruction to display the print setting screen from a user, the print setting screen is displayed in a state in which the specified printing apparatus is selected as the print data transmission destination.
